(19) United States
(12) Patent Application Publication
(10) Pub. No.: US 2019/0118775 A1
(43) Pub. Date: Apr. 25, 2019

(54) WIPER DEVICE

(71) Applicant: Robert Bosch GmbH, Stuttgart (DE)

(72) Inventors: Markus Koberstaedt, Buehl (DE); Ulrich Metz, Achern (DE)

(21) Appl. No.: 16/096,765

(22) PCT Filed: Apr. 20, 2017
(86) PCT No.: PCT/EP2017/059333

§ 371 Date: Oct. 26, 2018

(30) Foreign Application Priority Data
Apr. 28, 2016 (DE) 10 2016 207 271.4

(51) Int. Cl. B60S 1/08; B60S 1/04; B60S 1/16

(52) U.S. Cl. CPC B60S 1/08; B60S 1/163; B60S 1/0452

(57) ABSTRACT

The invention relates to a wiper device comprising at least one wiper drive (10) which is provided for driving a wiper arm (12) over a wiping region (14) of a vehicle window (16) in a direction-changing manner and comprising at least one control and/or regulating unit (18) which is provided for actuating the at least one wiper drive (10) in order to move the wiper arm (12) between a first wiping region boundary (20) and a second wiping region boundary (22). The wiper device comprises at least one interface (24) which is provided for establishing communication between the control and/or regulating unit (18) and an external end user unit (26), wherein the external end user unit (26) is provided at least for adjusting the first wiping region boundary (20).

### BACKGROUND OF THE INVENTION

A wiper device has already been proposed with at least one wiper drive, which is provided for driving a wiper arm in a directionally changing manner over a wiping region of a vehicle windscreen, and with at least one control and/or regulating unit that is provided for actuating the at least one wiper drive to move the wiper arm between a first wiping region boundary and a second wiping region boundary.

### SUMMARY OF THE INVENTION

The invention is based on a wiper device with at least one wiper drive that is provided to drive a wiper arm over a wiping region of a vehicle windscreen in a direction-changing manner, and with at least one control and/or regulating unit that is provided to actuate the at least one wiper drive to move the wiper arm between a first wiping region boundary and a second wiping region boundary.

It is proposed that the wiper device comprises at least one interface that is provided for communications of the control and/or regulating unit with an external end user unit, wherein the external end user unit is provided at least for adjusting the first wiping region boundary. As a result, particularly convenient readjustment of the wiping region can be achieved. The wiping region can be adjusted to the wishes of the end user in a particularly simple manner. The external end user unit is especially provided for the adjustment and/or variation of at least the first wiping region boundary by an end user. A “wiper drive” shall in particular mean a motorized drive of at least one wiper arm in this context. The at least one wiper drive preferably comprises at least one electric motor and/or a wiper transmission.

In this context, a “wiping region” shall mean in particular a region that is wiped over by a wiper lip of a wiper blade that is coupled to the wiper arm. The wiping region comprises in particular a contour with two straight boundary lines and two curved boundary lines, wherein the curved boundary lines join the straight boundary lines to each other. The vehicle windscreen preferably forms a front screen or a rear screen of a motor vehicle. A “control and/or regulating unit” shall in particular mean a unit with at least one control electronic means. A “control electronic means” shall in particular mean a unit with a processor unit and with a memory unit and with an operating program stored in the memory unit.

A “wiping region boundary” shall mean in particular a boundary line at which the wiping region ends in at least one direction in this context. The boundary line extends along a reversal line at which the wiper lip of the wiper blade changes direction during a reversing process. Ideally, the wiper lip should be considered to be straight. The interface advantageously comprises at least one communications unit.

An “external end user unit” shall mean in particular a unit that is embodied separately from the wiper device and that is provided for use by an end customer and/or a vehicle user in this context. Advantageously, the external end user unit is embodied to be portable. “Portable” in this context shall in particular mean with a mass of less than 5 kg, preferably of less than 1 kg, particularly preferably of less than 500 g. Advantageously, the external end user unit comprises an output unit and/or an input unit. The output unit preferably comprises a contact-sensitive display screen. “Provided” shall in particular mean specially programmed, designed and/or fitted. That an object is provided for a certain function shall in particular mean that the object fulfils and/or performs said certain function in at least one application and/or operating state.

In a further embodiment of the invention, it is proposed that the control and/or regulating unit is provided to set at least the first wiper region boundary exclusively within a fixed parameter framework depending on an input to the external end user unit via the interface. As a result, a particularly high operating reliability can be achieved. Furthermore, legal requirements on the wiping region can be complied with in a reliable manner. The fixed parameter framework advantageously describes a region in which the wiping region boundary can be freely placed. Alternatively, the fixed parameter framework describes a discrete number of possible wiper region boundaries, from each of which a wiping region boundary can be selected.

Furthermore, it is proposed that the external end user unit comprises a detecting unit that is provided for automatic detection of a wiper arm position and/or a wiper blade position and for at least partly automatic adjustment of at least the first wiping region boundary as a function of the wiper arm position and/or the wiper blade position. As a result, particularly convenient readjustment of the wiping region boundary can be achieved.

Furthermore, it is proposed that the interface is provided for wireless communications with the external end user unit. As a result, particularly convenient adjustment and/or variation of the wiping region can be achieved. Wiring of the external end user unit can be advantageously avoided.

In addition, it is proposed that the external end user unit is provided at least for the adjustment of the second wiping region boundary. As a result, particularly flexible adjustment of the wiping region can be carried out. Preferably, the control and/or regulating unit is provided to adjust at least the second wiping region boundary exclusively within a fixed parameter framework as a function of an input to the external end user unit via the interface.

Furthermore, it is proposed that the at least one wiper drive forms a reversing drive. As a result, a wiping region boundary can be particularly precisely adjusted. As a result, advantageously at least two wiper arms can be actuated mutually independently, and the wiping regions thereof can be adjusted. The wiper drive advantageously comprises a stepper motor.

Furthermore, it is proposed that the external end user unit is provided for at least partly automatic adjustment of the wiping region boundary as a function of at least one environmental parameter. As a result, a particularly user-friendly adjustment of the wiping region can be carried out. An “environmental parameter” shall in particular mean a screen state, a date, a time of day, a brightness, a degree of wetness of the vehicle windscreen, a surface quality of the vehicle windscreen, a mechanism and/or a weather parameter in this context.

Furthermore, it is proposed that the external end user unit is provided for the automatic detection of the at least one environmental parameter. As a result, particularly convenient adjustment of the wiper region for current ambient conditions can be achieved.

In addition, it is proposed that the external end user unit comprises at least one camera, which is provided for the optical detection of the wiper arm position and/or the wiper blade position. As a result, particularly intuitive and reliable detection of the wiper arm position for determining a wiping region boundary can be achieved.

In addition, it is proposed that the external end user unit is embodied as a cell phone, in particular a smart phone. As a result, the external end user unit can advantageously be integrated within an existing service solution. An additional investment for the cell phone by an end user is not necessary. Alternatively and/or additionally, it is conceivable that the external end user unit is embodied as a PC, a laptop, a tablet computer, a remote controller and/or a smart watch.

Furthermore, a system with a wiper device according to the invention and with an external end user unit is proposed.

Furthermore, a method is proposed for adjusting a wiping region boundary of a wiping region that is wiped over by a wiper blade of a wiper device, wherein the adjustment is carried out by means of an external end user unit that communicates with a control and/or regulating unit of the wiper device via an interface.

In addition, it is proposed that a wiping process is recorded and a distance of the wiper blade from an edge of the vehicle windscreen and/or an A-column is determined automatically. Furthermore, it is proposed that an individual optimal distance from the edge of the vehicle windscreen is determined. Furthermore, it is proposed that a parameter is automatically determined, with which the individual optimal distance from the edge of the vehicle windscreen can be adjusted. In addition, it is proposed that the parameter is transmitted by the external end user unit via the interface to the control and/or regulating unit and is stored. In particular, the wiper blade is then actuated based on the stored parameter until it reaches the individual optimal distance from the edge of the vehicle windscreen.

The wiper device according to the invention shall not be limited hereby to the application and embodiment described above. In particular, the wiper device according to the invention can comprise a number of individual elements, components and units that is different from the number mentioned herein to fulfil a functionality described herein.

### BRIEF DESCRIPTION OF THE DRAWING

Further advantages result from the following description of the drawing. An exemplary embodiment of the invention is represented in the drawing. The drawing, the description and the claims contain numerous features in combination. The person skilled in the art will advantageously also consider the features individually and combine them into meaningful further combinations.

In the FIGURE:

FIG. 1 shows a schematic design of a wiper device according to the invention.

### DETAILED DESCRIPTION

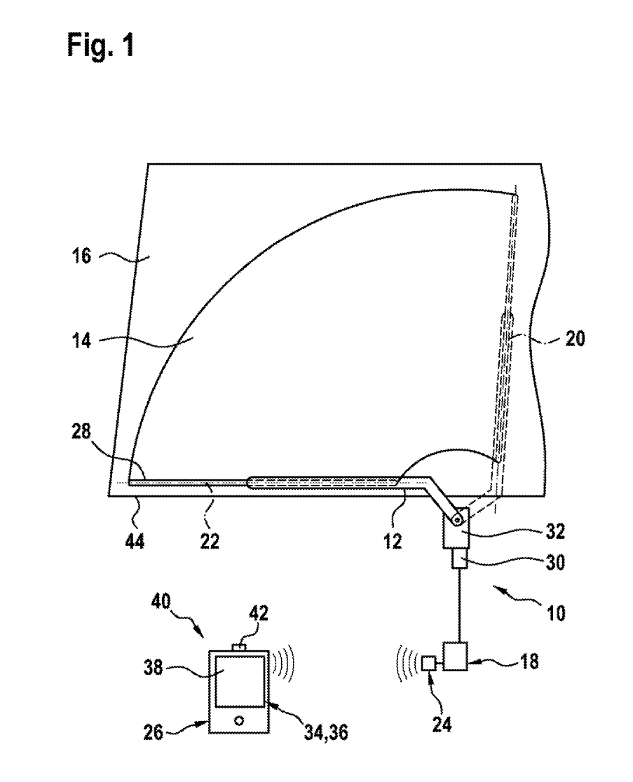

In FIG. 1, a possible design of a wiper device according to the invention is shown schematically. The wiper device comprises a wiper drive. The wiper device comprises a wiper arm. Furthermore, the wiper device comprises a wiper blade. The wiper blade is reversibly coupled to the wiper arm. The wiper blade is embodied as a flat wiper blade. The wiper blade comprises a wiper lip that is not shown and that wipes over a vehicle windscreen. The vehicle windscreen forms a front screen of a motor vehicle that is not shown. It is also conceivable that the vehicle windscreen is embodied as a rear screen of a motor vehicle. The wiper device can comprise at least one further wiper drive, a further wiper arm and/or a further wiper blade (not shown here).

The wiper drive 10 is provided to drive the wiper arm 12 over a wiping region 14 of the vehicle windscreen 16 in a direction-changing manner. The wiper drive 10 comprises an electric motor 30. The wiper drive 10 comprises a wiper transmission 32. The wiper drive 10 is embodied as a reversing drive. The electric motor 30 is embodied as a stepper motor. A direction of rotation of the electric motor 30 changes regularly during a wiping process. The wiper device comprises a control and/or regulating unit 18. The control and/or regulating unit 18 is provided to actuate the wiper drive 10 to move the wiper arm 12 between a first wiping region boundary 20 and a second wiping region boundary 22. The wiping region boundaries 20, 22 form boundary lines at which the wiping region 14 ends in a respective wiping direction.

The wiper device comprises an interface 24. The interface 24 is provided for communications between the control and/or regulating unit 18 and an external end user unit 26. The interface 24 comprises for this purpose a communications unit that is not shown in detail. The interface 24 is provided for wireless communications with the external end user unit 26. The interface 24 is provided for wireless communications according to an industry standard in accordance with IEEE 802.15.1 and/or in accordance with the IEEE-802.11 family.

The external end user unit 26 is provided for adjusting the first wiping region boundary 20. The external end user unit 26 is provided for adjusting and/or varying the first wiping region boundary 20 by an end user. The external end user unit 26 is embodied as a smart phone. However, it is also conceivable in this context that the external end user unit 26 is embodied as a PC, a laptop, a tablet computer, a remote controller and/or a smart watch. The wiper device and the external end user unit 26 together form a system.

The external end user unit 26 is embodied separately from the wiper device. The external end user unit 26 is provided for use by an end customer and/or a vehicle user. The external end user unit 26 is embodied to be portable. The external end user unit 26 comprises a mass of less than 500 g. The external end user unit 26 comprises an output unit 34. The output unit 34 is provided for the optical output of at least one parameter. In this case, the parameter can comprise in particular an angle value that describes a current wiping region boundary 20, 22 or a wiping region boundary that is to be set. It is also conceivable in this context that the output unit 34 is provided for an optical and/or haptic output of information and/or parameters. The external end user unit 26 comprises an input unit 36. The input unit 36 is provided for the input of information by an operator. In the exemplary embodiment shown, the output unit 34 and the input unit 36 form a contact-sensitive display screen 38.

The external end user unit 26 comprises a detecting unit 40. The detecting unit 40 is provided for the automatic detection of a wiper arm position. The detecting unit 40 is provided for the automatic detection of a wiper blade position. The external end user unit 26 comprises a camera 42 that is provided for the optical detection of the wiper arm position and/or the wiper blade position.

The detecting unit 40 is provided for the at least partly automatic adjustment of the first wiping region boundary 20 as a function of the wiper arm position and/or the wiper blade position. The detecting unit 40 is provided for the at least partly automatic adjustment of the second wiping region boundary 22 as a function of the wiper arm position and/or the wiper blade position.

The external end user unit 26 is provided for the automatic adjustment of the first wiping region boundary 20 as a function of an environmental parameter. The external end user unit 26 is provided for the automatic adjustment of the second wiping region boundary 22 as a function of an environmental parameter. The environmental parameter can in particular be a screen state, a date, a time of day, a brightness, a degree of wetness of the vehicle windscreen 16, a surface quality of the vehicle windscreen 16, a mechanism and/or a weather parameter. In this case, the external end user unit 26 is provided for the automatic detection of the environmental parameter.

The control and/or regulating unit 18 is provided to adjust the first wiping region boundary 20 exclusively within a fixed parameter framework as a function of an input to the external end user unit 26 via the interface 24. The control and/or regulating unit 18 is provided to adjust the second wiping region boundary 22 exclusively within a fixed parameter framework as a function of an input to the external end user unit 26 via the interface 24. In this case, the fixed parameter frameworks correspond to the legal and/or technical requirements that absolutely must be complied with by a wiper drive.

For the adjustment of the wiper region boundaries 20, 22, an end user inputs the desired wiper region boundaries 20, 22 into the external end user unit 26. The external end user unit 26 interprets the inputs and determines corresponding parameters. The parameters are transmitted wirelessly via the interface 24 to the control and/or regulating unit 18 of the wiper device.

In addition or alternatively, the wiping process can be recorded by the detecting unit 40, and a distance of the wiper blade 28 from an edge 44 of the vehicle windscreen 16 can be determined automatically. In this case, an individual optimal distance from an A-column that is not shown here can be determined. A parameter is then automatically determined by the external end user unit 26, with which the individual optimal distance from the edge 44 can be adjusted. The parameter is transmitted from the external end user unit 26 via the interface 24 to the control and/or regulating unit 18 and is stored there. The wiper blade 28 is then accurately moved to the individual optimal distance based on the stored parameter and changes the direction of motion thereof there.

1. A wiper device comprising at least one wiper drive (10) that is provided to drive a wiper arm (12) in a direction-changing manner over a wiping region (14) of a vehicle windscreen (16), at least one control and/or regulating unit (18) that is provided to actuate the at least one wiper drive (10) to move the wiper arm (12) between a first wiping region boundary (20) and a second wiping region boundary (22), and at least one interface (24) that is provided for communications between the control and/or regulating unit (18) and an external end user unit (26), wherein the external end user unit (26) is provided at least for adjusting the first wiping region boundary (20).

2. The wiper device as claimed in claim 1, characterized in that the control and/or regulating unit (18) is provided to adjust at least the first wiping region boundary (20) exclusively within a fixed parameter framework as a function of an input to the external end user unit (26) via the interface (24).

3. The wiper device as claimed in claim 1, characterized in that the external end user unit (26) comprises a detecting unit (40) that is provided for the automatic detection of a wiper arm position and/or a wiper blade position and for the at least partly automatic adjustment of at least the first wiping region boundary (20) as a function of the wiper arm position and/or a wiper blade position.

4. The wiper device as claimed in claim 1, characterized in that the interface (24) is provided for wireless communications with the external end user unit (26).

5. The wiper device as claimed in claim 1, characterized in that the external end user unit (26) is provided at least for adjusting the second wiping region boundary (20).

6. The wiper device as claimed in claim 1, characterized in that the at least one wiper drive (10) is a reversing drive.

7. The wiper device as claimed in claim 1, characterized in that the external end user unit (26) is provided for the at least partly automatic adjustment of the wiping region boundary (20) as a function of at least one environmental parameter.

8. The wiper device as claimed in claim 7, characterized in that the external end user unit (26) is provided for the automatic detection of the at least one environmental parameter.

9. A system with a wiper device as claimed in claim 1 and with an external end user unit (26).

10. A method for adjusting a wiping region boundary (20) of a wiping region (14) that is wiped over by a wiper blade (28) of a wiper device, characterized in that the adjustment is carried out by means of an external end user unit (26) that communicates via an interface (24) with a -control and/or regulating unit (18) of the wiper device.
